(19) United States
(12) Patent Application Publication
(10) Pub. No.: US 2022/0335399 A1
(43) Pub. Date: Oct. 20, 2022

(54) TELEMETRY SYSTEM TO AUDIT TRANSFERS ON ELECTRONIC APPARATUS OR DEVICES FOR PAYMENT

(71) Applicant: EZURA, LLC, DENVER, CO (US)

(72) Inventors: Juan Alberto LEDESMA DEL RIO, Monterrey (MX); José Pablo GARCÍA ESTRADA, Monterrey (MX)

(21) Appl. No.: 17/641,005

(22) PCT Filed: Oct. 8, 2020
(86) PCT No.: PCT/IB2020/059442

§ 371 Date: Mar. 7, 2022

(30) Foreign Application Priority Data
Aug. 14, 2020 (MX) MX/A/2020/008567

(51) Int. Cl. G06Q 20/20; G06Q 20/02; H04L 9/40; G07F 17/32

(52) U.S. Cl. CPC G06Q 20/202; G06Q 20/027; H04L 63/0272; G07F 17/3234; G07F 17/3223; H04L 12/4641

(57) ABSTRACT

The instant invention is related to a telemetry system with devices designed for the specific purpose of auditing transactions within a network. The network infrastructure is specifically configured to provide power to all the connected devices from a single power source. The electronic memory within each module of the system is able to store data locally to prevent data loss if the network is not available for data transfer. Furthermore, a gateway is provided to allow communication to a central database or to store data if a remote network is not available. The system may include a web portal hosted by a dedicated server designed for providing stability and a specific user interface showing only the relevant acquired data to specific users.

This application is a U.S. National Stage of International Application No. PCT/IB2020/059442, filed Oct. 8, 2020. This application also claims the benefit of the Aug. 14, 2020 filing date of Mexican Patent Application No. MX/a/2020/008567, upon which the International Application is based. The contents of both of the foregoing applications are incorporated herein by reference.

### FIELD OF THE INVENTION

The present invention relates generally to electronic gaming or videogame machines or devices, register boxes, apparatus or electronic charging devices that make electronic transfers, cash transfers, ticket transfers or any other electronic means for transferring credits from said machines and having a network communication protocol between them and to systems and methods to audit such transfers.

### BACKGROUND OF THE INVENTION

The instant invention is related to a telemetry system with devices electronically designed for the specific purpose of auditing transactions within a network. Furthermore, the network infrastructure is specifically configured to provide power to all the devices connected using a single power source. The electronic memory within each module of the system is able to store data locally to prevent data loss if the network is not available for data transfer. Furthermore, a gateway is provided to allow communication to a central database or to store data if a remote network is not available.

On the other hand, it comprises a web portal hosted by a dedicated server designed for providing stability and a specific user interface showing only the relevant acquired data to specific users.

The electronic devices already known in the art do not collect the information from the audited devices if any part of the system or the central database is offline or unreachable. These devices do not perform a route search toward said persistent database or toward any alternative database.

Furthermore, the accounting books information and the statistics of the meters or of the credits cannot be reviewed since the devices do not comprise a proper display to present the collected information.

Likewise, the prior art devices require further infrastructure, such as cables or power sources, since normally, such devices are not designed ad hoc but using standard electronic platforms already available in the market, such as microcomputers, development kits provided by large scale manufacturers or designed by third parties that may not be aware of the specific issues of the interconnected gambling machines system. This infrastructure further imposes the problem of an enlarged probability of failure, shortening the lifetime expectancy of the overall system.

Likewise, a significant delay on the synchronization of said devices with the central data base and the web page has been observed specially when network problems happen. Such problems may include a failure on the connection to the intranet or to the internet gateway, devices that become offline due to an energy shortage, device disconnection from the machine to be audited, etc. No warnings or alerts are triggered toward the responsible staff by e-mail, SMS, chats or any other means to inform of such events.

Furthermore, Ethernet protocol is extensively used within network connected devices. The extensive use of the Ethernet protocol makes such systems vulnerable to hackers and network intrusions. As a result, the integrity of the systems could be compromised by its mere use.

Additionally, it is a main object of the instant invention to provide a feature to intervene, by immobilization of the gaming machine. Such immobilization can be instructed by any of the acting entities of the gaming machine, such as a government or a particular entity which is auditing the gaming machine.

Several attempts have been made to try to overcome some of the above-mentioned technical problems. A brief discussion on some of the documents disclosing systems, devices and methods pertaining to the prior art is presented herein below:

Document U.S. Pat. No. 8,197,344 B2 discloses a data monitoring system wherein a gaming terminal and a dedicated computer, as well as one or more servers are connected in a network. The described methods are used to store data received from a set of terminal gaming equipment in communication following the series communication protocols. In this document, it is stated that, although the information is stored locally on each computer, means are also provided to store data in secure remote servers.

The information is monitored and captured directly on each gaming terminal with a communication interface, which converts the captured data so that it is ready to be sent through a network and stored in a server.

This document also discloses the use of several LAN topologies and that the system can be extended through a WAN network.

Nevertheless, this patent discloses only the connection on machines comprising a single communication port. As will be further discussed, the instant invention provides solutions for machines having both one, two or more communication ports. Furthermore, in this document, each measure device is connected directly to a LAN or a WAN network which makes the overall system more expensive technically and economically, since complex communication tasks are performed by the auditing modules. Likewise, a single power source is required per each module. Such restriction makes it impossible to disconnect a machine in case of immobilization by the auditor, which can be official, like a government entity or particular, like the owner of the device.

Furthermore, patent disclosure U.S. Pat. No. 8,088,014 B2 discloses a peripheral device attached to a gaming machine which is configured to improve the gaming features, for example, by allowing possibilities of network connection, monitoring data and online updating, improvements on the player monitoring and security, and improvements in the player rewards.

The system provides a set of improved gaming features that are non-intrusive in such way that the regulated software of the gaming machines is not altered.

Remarkably, this document reveals interfaces and communication means for exchanging data in several networks that can be independent for each of the features improved by the device. Said communication is performed between the peripheral device and several servers by a local network or remote networks.

Likewise, the peripheral device has its own display and is able to communicate with other similar peripheral devices or with other gaming machines and its displays.

However, the device disclosed in US Patent '014 is not an audit system, but a system to display ads and promotions and providing a further visual display to the machine by manipulating the light mounted on each of the machines.

On the other hand, document U.S. Pat. No. 9,640,022 B2 discloses devices and methods to generate and/or communicate data in an image form. In this document, methods are included to receive information from a first wager gaming device through a local area network. This information is formatted in such way that an image is readable by a machine, for example, by means of a QR code or any other barcode. Within the codified data, unique identifiers of each gaming machine are included. The image-codified information is presented in a display.

The gaming systems of this patent communicate via a local area network and exchange information regarding the games played by the user, device features and data from the player. It is possible to associate physical elements to a money value by receptors of such means in the gaming devices and determine a credit line for the player.

Furthermore, methods are revealed to exchange information between a gaming device, a physical money value element and the image-codified information presented in a display with a mobile device.

Nevertheless, no disclosure is made regarding further communication to transmit the acquired data to a central database, or the performance of the devices on a situation in which normal communication is not available.

Now then, the system disclosed in U.S. Pat. No. 8,070,605 B2 provides a control and management solution for gaming devices linked in a progressive gaming environment. The system is designed to monitor multiple meters in such way that a plurality of rewards is maintained in a progressive manner per each game or for the multiple entities participating in a contest. The management of the system can be carried out remotely.

In the case that the system loses communication with the progressive gaming environment, one or more machines can be linked automatically to the progressive behavior while a disconnection is happening. Likewise, US Patent '605 describes the procedure to exchange information between the peripheral devices and a central control device when a failure in communication occurs.

However, said document is related to reward systems to make the games more attractive to the final user. No relevant information is extracted from the gaming devices to provide the possibility of auditing its charges on fees, royalties or taxes. Therefore, the relevance of acquiring, processing and/or transmitting delicate information is neither disclosed nor suggested.

Patent document U.S. Pat. No. 9,165,422 B2 discloses a gambling game system and its operating methods. It details the manner in which a player can begin a game remotely and monitor the interaction between members of a group locally or remotely. In this system, the control of the game is provided by different players connected by a local area network or a remote network. Essentially, this system facilitates group wagering. By no means does it provides a solution to auditing the acquired data.

Likewise, document U.S. Pat. No. 8,092,303 B2 discloses a convenience gaming system allowing its users to access applications by means of communication devices coupled to a communications network. Applications can be gaming, financial, entertainment service or other transactions. For this system, it is particularly useful to receive the location of the user in such way that transactions are a not allowed when the user is located in certain areas. As a person skilled in the art would easily understand, providing means to manipulate a gaming machine remotely is not the same as providing a solution to audit the data on the transactions of the same gaming device.

Finally, U.S. Pat. No. 9,111,078 B2 discloses a management system for slot machines allowing a user to monitor, control and modify the gaming devices. Furthermore, it provides authentication methods between the data collecting devices and the control points and allows distribution of software to the slot machine terminals. However, such system is designed to work with multigaming devices by changing the games and its configuration. Accordingly, it is by no means related to an independent audit system as the one disclosed herein.

Although some of the aforementioned documents might seem to disclose some of the features of the instant invention, neither of said documents disclose, for example, the specific manner in which the retrieved data is stored, processed, transferred, analyzed and displayed to the final user. The aforementioned documents also do not disclose the manner in which the slave and master devices are fed with energy or the technical impact of having a common energy source. Likewise, none of the documents disclose independent audit systems that can be adapted to machines comprising one or several communication ports and that provide the machines with the ability to react to certain events such as disconnections, lack of payments or responding to direct orders of the auditing entity, and that have simple and economic means to connect, simplified and specific task oriented modules and reduced power sources.

### SUMMARY OF THE INVENTION

To solve the aforementioned problems, the present invention provides several embodiments of a telemetry system and methods that are focused on auditing electronic transactions from electronic devices such as electronic gaming or videogame machines or devices, register boxes, apparatus or electronic charging devices making electronic transfers, cash transfers, ticket transfers or any other electronic means for transferring credits from said machines. The telemetry system has a network communication protocol to enable communications between the devices. The inventions also relates to systems and methods to audit such transfers.

The system herein disclosed comprises a plurality of modules, which can differ on their hardware features and their software configuration. The software of the modules take advantage of the hardware of the system to provide a data acquisition system. Such a system is powered by a single power source, in spite of the several modules being linked together. The power is fed from the power source to the several modules by the same cables transmitting data to the network. Thus the connection between the different elements of the network is simplified by providing the possibility of using a single cable to both transfer data and to power the devices connected to the system. Furthermore, this configuration provides means to simplify the network topology in such way that any disconnection of a module is reported the rest of the elements and a proper response can be provided by the system.

The integral platform comprises software and hardware, having multiple solutions that have been configured to maintain data and events, having a high availability in the synching tasks with the central database to present actual reliable data to perform the book accountability and to manage alerts and alarms of events that are deemed to be useful for a user of the telemetry system.

The hardware arrangements provide for easy and quick installation, include a single power source for all the connected devices and allow for the possibility of accessing each device using a display connected to each device.

The different modules can be, per example, smart master modules, which comprise means for electrically acquiring data from the electronic device being audited, a memory storage, at least one processor and a communications device.

On the other hand, the system can include one or a plurality of slave devices which may comprise means to be connected to an electronic device being audited; a secure memory storage; a processor; and a communications device.

Each of the slave devices are connected directly to a single electronic gaming machine, the slave device acquires data from such electronic gaming machine and stores the data so that it can be processed and sent to the master devices.

The master devices coordinate the plurality of slave devices, compiling the information received from the slave devices and providing a safe environment for the information to be processed and sent to a gateway that will send the information to a central database.

At this stage, the information will be prepared to be conveniently displayed to the auditing entity.

Each of the modular devices, either master or slave, comprises secure memory devices, wherein the acquired data is stored. If a failure in communication is detected between a slave device and the master device, the data acquired is stored in the secure memory device of the disconnected slave device while it is offline. Once the connection is recovered, the data is synchronized with the processor, said processor then processes the data in order to correctly package it and prepare it for sending to the master device.

The information received from each slave device is processed on the processor of the corresponding smart master device and is prepared for uploading to a central data base, for example, a cloud centralized data base, a dedicated server or any other means for storing the resulting data. When the information has been duly processed, it is sent to a gateway device.

The data received by the gateway device is ultimately uploaded to the central database by encapsulating the data and uploading it through a local or remote network or by any other communication method available for both the gateway and the receiving server. The information is securely uploaded using encoding algorithms, cyphering processes, secure certificates, virtual public networks or by any other secure method that can ensure safe transfer of data.

The acquired data includes information regarding the electronic transactions performed by the electronic gaming devices or any other kind of device being audited by the system and which the slave device is connected to.

The receiving server is then configured to process the information for display to the auditing entity.

Furthermore, the receiving server is capable of transmitting commands to the slave devices, which are sent through the gateway devices and the master devices. Such commands may allow the auditing entity to perform actions on the audited devices using the network connection of the telemetry system disclosed herein. Said actions may comprise, for example, a pause, an interruption or a complete halt in the function of a determined gaming device.

The information is displayed by a web based portal hosted on a dedicated server or using display screens connected to each of the devices using a special display interface.

The communication protocols used and suggested by the present invention are standardly used in several computers pertaining to a plurality of fields such as those in the car industry or the aeronautic industry, providing reliability and high availability. Likewise, electric noise, temperature failures, cabling failures and similar issues are prevented from contaminating the data transfers.

Furthermore, the data is configured to be displayed using specific web based, application based and server based technology.

### BRIEF DESCRIPTION OF THE DRAWINGS

FIG. 1 is a schematic diagram showing the proposed power source connections on a communications port according to the instant invention;

FIG. 2 is a block diagram of a first device embodying the disclosed technology connected to a wired and a wireless network;

FIG. 3 is a block diagram of a second device embodying the disclosed technology that includes serial data input/output ports;

FIG. 4 is a diagram of a system embodying the disclosed technology in which smart master units communicate with a gateway device via a wired network;

FIG. 5 is a diagram of a system embodying the disclosed technology in which smart master units communicate with a gateway device via a first type of wireless link;

FIG. 6 is a diagram of a system embodying the disclosed technology in which smart master units communicate with a gateway device via a second type of wireless link;

FIG. 7 is a diagram of elements of a system embodying the disclosed technology in which pointing devices are connected to slave units that are themselves connected to electronic device; and

FIG. 8 is a diagram of elements of a system embodying the disclosed technology in which both pointing devices and slave devices are both connected to electronic devices.

### DETAILED DESCRIPTION

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

The instant invention comprises a telemetry system and methods that are focused on auditing electronic transactions from electronic devices such as electronic gaming or videogame machines or devices, register boxes, apparatus or electronic charging devices making electronic transfers, cash transfers, ticket transfers or any other electronic means for transferring credits from said machines. For the sake of language simplicity, the term “electronic gaming device” is used to refer to any of the above mentioned examples or any other kind of device available to interact with the telemetry system disclosed herein.

The system herein disclosed comprises a plurality of modules, each of which can differ on its hardware features and its software configuration. The overall system is referred to within this specification as the “telemetry system.”

The so-called “modules” are devices that are interconnected in a modular way, in such way that the devices can be connected or disconnected from the network and transported to a different entity of the system monitoring a different set of gaming machines.

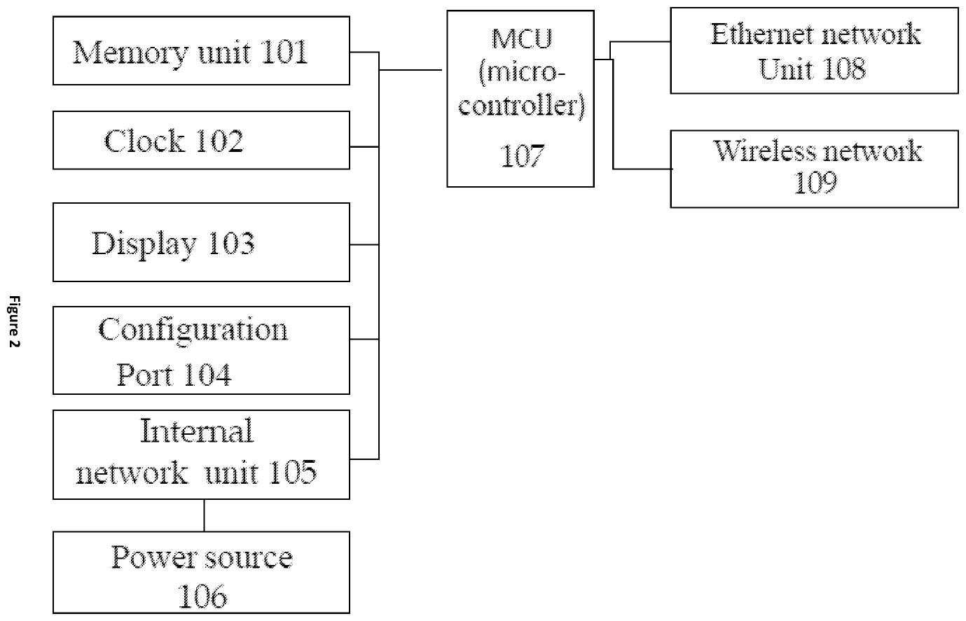

FIG. 2 illustrates the basic elements that can be included in a smart master device, details of which are discussed below. Each smart master device can include a memory unit 101, a clock 102, a display 103, a configuration port 104, an internal network unit 105 and a power source 106, all of which are connected to a microcontroller (MCU) 107. In the embodiment illustrated in FIG. 2, the microcontroller 107 communicates over a wired network, such as an Ethernet network 108 or over a wireless network 109.

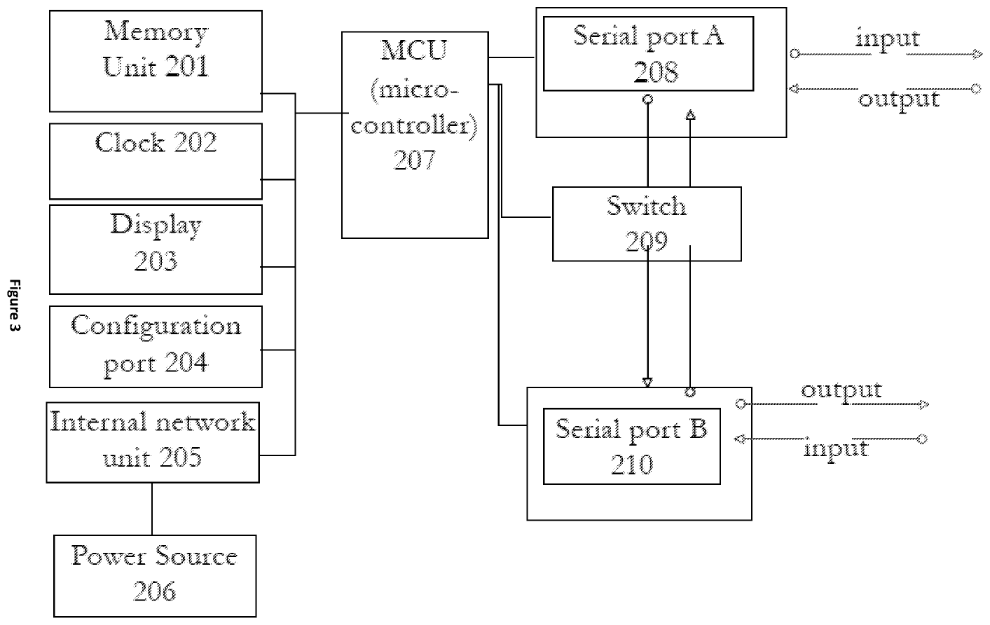

FIG. 3 illustrates the basic elements that can be included in a slave device, details of which are discussed below. Each slave device can include a memory unit 201, a clock 202, a display 203, a configuration port 204, an internal network unit 205 and a power source 206, all of which are connected to a microcontroller (MCU) 207. In the embodiment illustrated in FIG. 3, the microcontroller 207 communicates over a wired network via a first serial port 208 and a second serial port 210 which are connected to a switch 209.

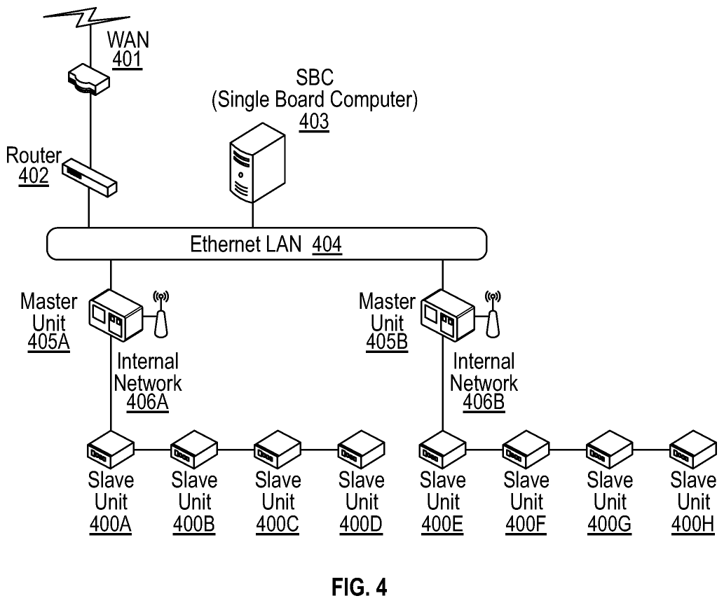

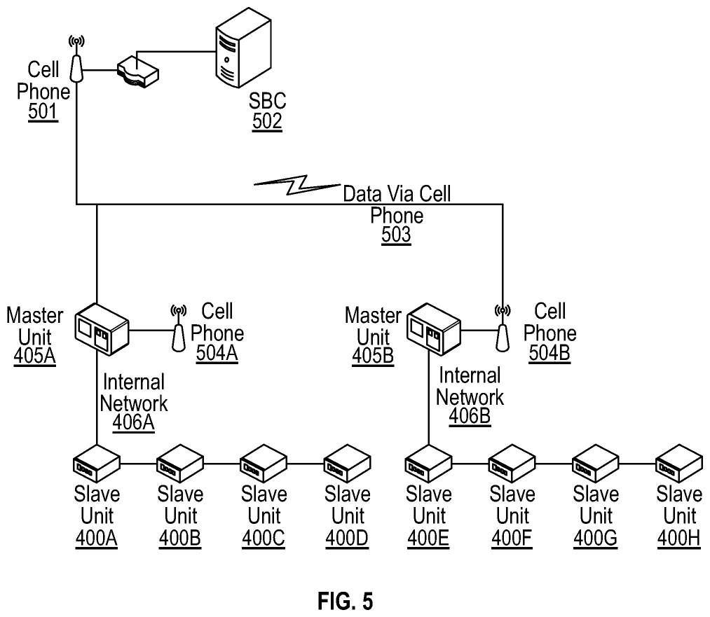

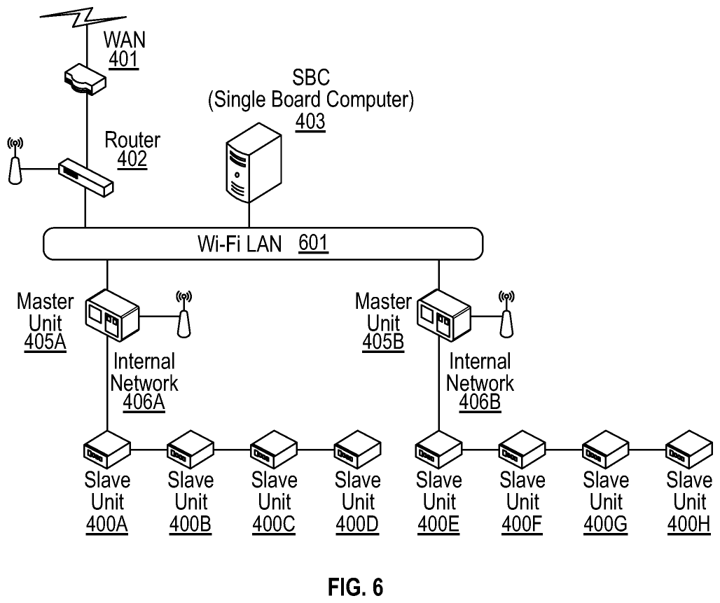

FIGS. 5, 6 and 7 illustrate systems embodying the disclosed technology, the primary difference between these embodiments being the technology that the smart master units 405A/405B use to communicate with a gateway or router 402 and/or a single board computer (SBC) 403/502. In the each of these examples, the master units 405A/405B communicate with slave units 400A/400B/400C/400D/400E/400F/400G/400F via a wired internal networks 406A/406B. In the embodiment illustrated in FIG. 4, the master units 405A/405B communicate with a router 402 and a single board computer (SBC) 403 via a wired network, such as an Ethernet 404. In the example illustrated in FIG. 5, the master units 405A/405B communicate with a SBC 502 via wireless technology, such as a cellular telephone network 503. This involves the use of cellular telephones 504A/504B connected to the respective master units 405A and 405B and a cellular telephone 501 connected to the SBC 502. In the example illustrated in FIG. 6, the master units 405A/405B communicate with a router 402 and a SBC 403 via a wireless network, such as a WiFi network 601. The router 402 in turn is connected to a wide area network (WAN) 401, such as the Internet.

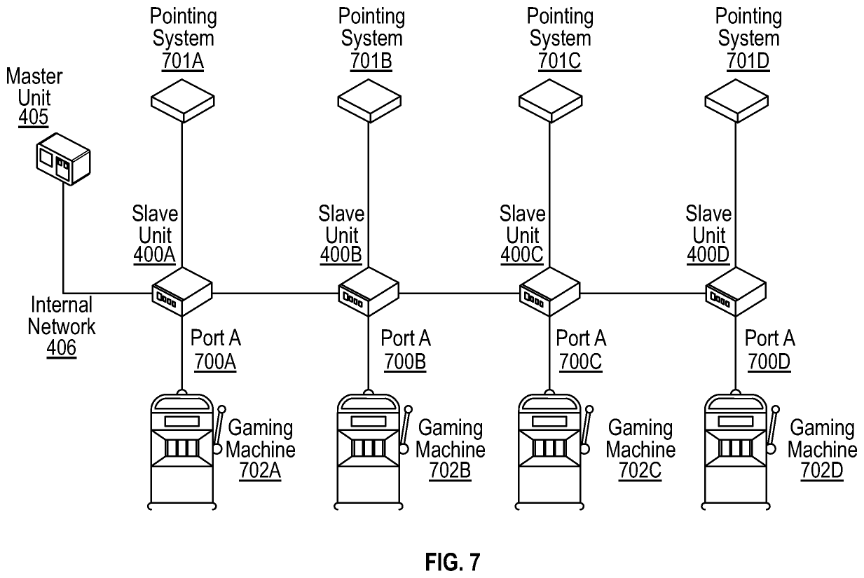

FIG. 7 illustrates a first way that slave units 400A/400B/400C/400D and pointing systems 701A/701B/701C/701D are connected to electronic devices such as gaming machines 702A/702B/702C/702D. In this example, the pointing systems 701A/701B/701C/701D are connected to the slave units 400A/400B/400C/400D, and the slave units 400A/400B/400C/400D are connected to respective Port As 700A/700B/700C/700D of the gaming machines 702A/702B/702C/702D.

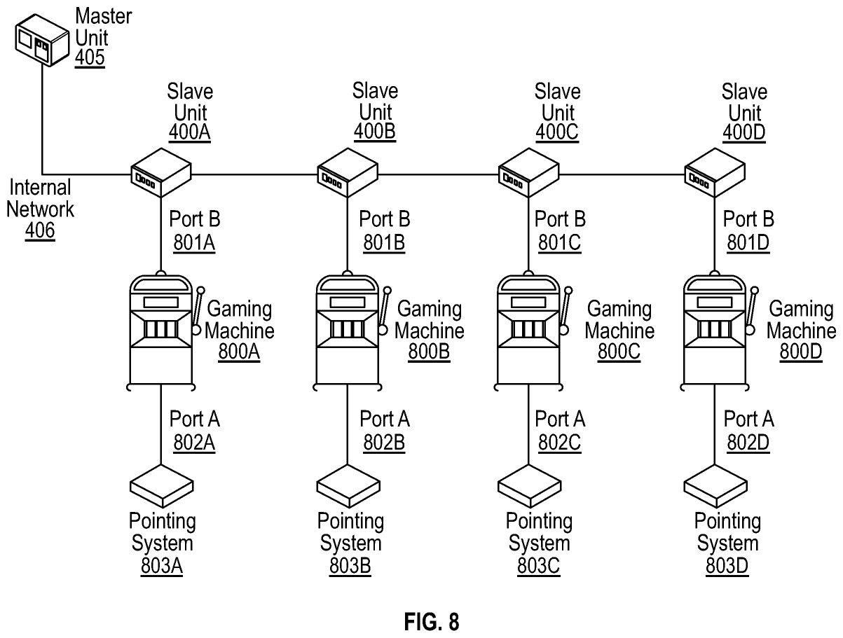

FIG. 8 illustrates a second way that slave units 400A/400B/400C/400D and pointing systems 803A/803B/803C/803D are connected to electronic devices such as gaming machines 800A/800B/800C/800D. In this example, the pointing systems 803A/803B/803C/803D are connected to respective Port As 802A/802B/802C/802D of the gaming machines 800A/800B/800C/800D and the slave units 400A/400B/400C/400D are connected to respective Port Bs 801A/801B/801C/801D of the gaming machines 800A/800B/800C/800D.

In an embodiment of the invention, such modules can be, for example:

Slave Devices: Data Capture or Data Acquisition Devices, One for Each Audited Device

These devices are in charge of electrically collecting data from an audited machine, system or device. Said data collection can be performed using a serial electric protocol such as, for example, RS232, RS422 or a SAS or LAB communication protocol. Furthermore, the collected data can be sent through a cable data network, for example a UTP, serial, or any other kind of communication cable connected to a master device.

Preferably, a CANbus protocol is used to connect a slave device to a master device. Energy is provided to the slave device from a power source through the same set of network communication cables that communicate data between the slave device and the master device.

Furthermore, if no connection to the master is available, the processor within the slave device is configured to detect the failure in the connection. Accordingly, if such failure is detected, a message with information regarding the disconnection is prepared to be sent to the master device upon re-connection. Likewise, the data acquired by the slave device is properly stored in its internal memory until connection to the network is restored. Information regarding open doors, energy failures and connection losses is also stored and eventually sent to the master devices.

These slave electronic devices comprise hardware elements such as a microcontroller processing unit, a PCB plate with electronic active and passive devices and circuits such as further controllers, peripheral modules, clocks, connectors, memory modules and backup power storage, such as batteries or energy storage arrangements.

Master Devices: Data Collecting Devices that Gather the Data Acquired By the Slave Devices

These devices are in charge of collecting the data acquired by the slave devices through the cable network connections and sending the collected data through a different network connection to a gateway module. The network connection to the gateway module can either be wired using cable connections or wireless, using a radio transmitter or by any other means for transmitting data available for both the gateway and the master device.

Furthermore, the master device may host the power source providing energy to the slave devices using the same cables used for communication between slave devices and the master devices.

Likewise, the master device is configured to prepare messages regarding its own power or communication disconnections as messages that are eventually sent to the gateway module.

The master device or devices comprise each a microcontroller brain, a PCB plate with electronic active and passive devices and circuits such as further controllers, peripheral modules, clocks connectors, memory modules and backup power storage, such as batteries or energy storage arrangements.

In preferred embodiments, each of the slave or master devices comprises a screen display, which presents information to identify the device, such like an alias and its location, its network address, and a numeric meter register providing the functionality of displaying statistical and historical information of the acquired data.

Power and Data Transmission

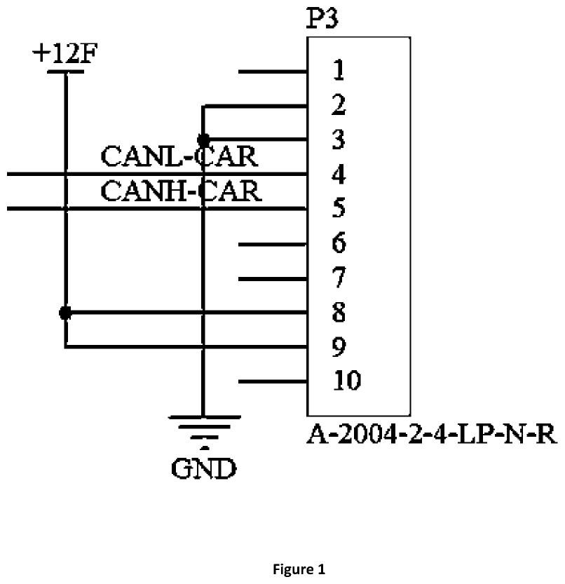

In a preferred embodiment of the invention, eight-channel network cables divided in four pairs are commonly used for economic and technical reasons, since such interfaces have been proved reliable and safe. However, FIG. 1 shows modifications performed by the inventors to the standard connections of a four pair cable set.

Specifically, on preferred embodiments of the invention, only two cables are used to send a differential signal, making such signal very tolerant to noise. Furthermore, another pair is used for sending a direct current voltage and a third pair is used to provide a ground reference signal, allowing power feeding to other modules.

The connection on slave modules is the same as that shown in FIG. 1, however, slave modules have an input port for a network cable and a further output port for another network cable towards another slave module. This arrangement allows the system to keep expanding by adding the necessary cables and modules, as long as the strength of the signal is maintained and the protocol allows the connection of further slave modules.

The specific hardware arrangement for the devices provides the possibility to manufacture size-made enclosures, thus allowing using materials adequate to prevent opening or alteration on the hardware, for example, using transparent walls for the enclosure, signaling tags and safe connectors for the cables.

Gateway Devices: Routing Data Towards Cloud Storage and/or Central Database Servers

These devices are in charge of collecting data by means of the cabled network, for example UTP or Ethernet protocol network or by the radio link using a radio signal. The gateway collects the data from the master devices and the collected data is sent using the network connection to a persistent storage which can be internet or cloud based, or to a dedicated server hosting the central database.

The data received by the gateway device is ultimately uploaded to the central database by encapsulating the data and uploading it through a local or remote network or by any other communication method available for both the gateway and the receiving server. The information is securely uploaded using encoding algorithms, cyphering processes, secure certificates, virtual public networks or by any other secure method that can ensure safe transfer of data.

The gateway also gathers information regarding its own power disconnections or failures in communication to the network. Furthermore, the gateway can search for alternative internet connections in order to maintain the communication with the central database server.

In preferred embodiments, the gateway device is a micro or nano-personal computer running a Linux operating system. However, this personal computer could be running any other operating system that allows network communication and server capabilities, such as Windows, UNIX or any other OS available for a personal computer hardware. These kind of devices are in widespread use due to their high performance, functionality, life expectancy, stability and availability.

Modem Devices, Mobile Internet Router

The telemetry system may also comprise internet connection devices supporting the gateway and providing communication with the central database. This connection may me made by a cabled internet service, but can also be made by mobile internet systems. These possibilities provide external connection to the gateway devices.

Central Database

The system acquiring data from the devices stores the information in a central database, which maintains the historical data and the statistics computed on the overall system. Furthermore, the central database hosts the data to be provided to the platform or web site and or external software for data presentation. This central database is based on any available system for data storage, such as SQL, PostgreSQL, NoSQL databases or any other system.

Web Server

A web server is provided to host and serve any web page services using new and legacy technologies providing improved support by balancing proxy virtual servers, and performing visitor load balancing within the served web sites. The web server is configured to manage interactions between programming languages, web site and data bases in a specifically configured web service platform.

The notification system installed on the master device and the gateway send alerts and alarms to the users if the system is detected to be offline for an exceeded time threshold, which can be configured in seconds, per example, six hundred seconds.

Web Site

The specially designed web page provides access to the data stored in the web server. This web page is programmed, for example, using languages such as Python, PHP, HTML5, CSS3 and the similar languages, having multiuser input support to provide permission policies for reviewing and accessing data.

The web site is configured to allow exporting the data to common kinds of documents such as pdfs, xls, csv files and similar document formats.

Specific pages are programmed for the system allowing the display of information to the auditing entities. Some examples of such specific pages are:

Totals page: Displays compact information regarding the book accountability of the several meters, such as inputs, outputs and data obtained in simple indicative numbers that show the sum, average, media, and other transformation of the data provided by all the devices arranged day by day or containing the entire month.

Alerts page: Displays a chronologically arranged table with the filtered events regarding, for example, open doors, disconnections from the SAS or other communication protocol, network disconnections, device resets, abnormal data increments, full turn of the meters, and other relevant data regarding the infrastructure of the system.

Events Log page: This page displays a table containing all the events provided by the devices chronologically arranged, to have a complete status of the data and to keep register of the events since the arrival of the data to the central database server.

Inventory register page: This page provides interfaces for filling forms and registers as well as for editing such forms. It shows the number of devices selected from a table and provides all the parameters to be filled by the user in order to link such device with the machine or system being audited, with fields such as serial numbers, location, model, mark, kind of machine and similar fields. Likewise, alert notifications can be configured from the web platform.

The overall set of devices within the telemetry system are connected amongst them and are also connected to the audited gaming devices. An exemplary description of the connections between the elements using an example of the telemetry system is now disclosed. However, this connection is not restrictive or limiting to the scope of the invention, since, as previously disclosed, the specific kinds of hardware, connections and protocols disclosed herein below could be updated using the most recent technologies available without compromising the novelty or inventive step of the instant invention, as such arrangements have been already regarded by the inventors.

As previously mentioned, the slave module is positioned on each gaming machine intended to be audited or monitored. The slave module is divided on the following layers:

SAS port
CAN port
Meter review
Meter storage
Meter sender
Meter file delivery
Slave device

Specifically, the SAS port is in charge of sending messages using a standard machine protocol known as SAS. The measurements and status messages are transferred through this port. Furthermore, said messages can comprise instructions to activate or deactivate the gaming machine.

The CAN port is in charge of sending messages between the slaves and the master of the telemetry system network. This port is also in charge of receiving power to activate the slave devices.

The meter review is part of the configuration of the slave device and is in charge of requesting data from the gaming machine periodically according to a preset schedule.

The meter storage is a memory storing the status of the meters before sending the data to the master device. This reduces the tasks of the master device in terms of amount of information and serves as a data backup in case of disconnection with the master or with the server, thus working as a temporary data storage while the slave device is offline.

The meter sender configures the processor to manage the data exchange between the slave, the master and the server, verifying that the data was sent and received before it is erased from the inner storage.

The meter file delivery is in charge of detecting interruptions on the message sender, creating a file containing information regarding the status of the slave device, data regarding the disconnection details and the acquired data. The meter file delivery is also in charge of sending the data once the communication is restored or allowing data extraction using an external storage, for example a USB memory storage using a USB port. Likewise, the external storage could be any other possible storage that can be connected to the slave device, such as an external hard disk drive, an external memory module or any other memory storage means.

The master module is configured to receive the slave module information, which in this case is transmitted using a CAN protocol. The received data is then sent to the cloud based server. The layers of the master device are, for example:

CANport
Meter review
Meter storage
Meter sender
Meter file delivery
Master device

The CAN port is in charge of sending messages between the slaves and the master of the telemetry system network. This port is also in charge of sending power to activate the slave devices.

The meter review is part of the configuration of the master device and is in charge of requesting the data from the slave devices periodically according to a preset schedule.

The meter storage is a memory storing the status of the meters before sending the data to the gateway device or to the central database server. The meter storage also serves as a data backup in case of disconnection from the network, thus working as a temporary data storage while the master device is offline.

The meter sender configures the processor to manage the data exchange between the slave, the master and the server, verifying that the data was sent and received before it is erased from the inner storage of the master device and before sending a message to the slave device indicating that the data can be erased from the inner storage of the slave device.

The meter file delivery is in charge of detecting interruptions on the message sender, requesting the backup information from the slave device files and creating a file containing information regarding the status of the master device, data regarding the disconnection details and the acquired data. The meter file delivery is also in charge of sending the data once the communication is restored or allowing data extraction using an external storage, per example a USB memory storage using a USB port. Likewise, the external storage could be any other possible storage that can be connected to the slave device, such as an external hard disk drive, an external memory module or any other memory storage means.

Two port gaming machines have a port dedicated for the pointing system and one for the auditing system. According to the instant invention, it is not necessary to intercept the messages of the pointing system to acquire information. Therefore, using the specialized auditing system port, the data can be acquired and the gaming machine can be activated or de-activated.

Two port gaming machine
Meters

| | |
|---|---|
| From the | From |
| cashier system | accountability |
| SAS | SAS |
| protocol | protocol |
| AFT/EFT | |
| Port 1 | Port 2 |

On the other hand, the instant invention can work with one port gaming machines lacking a specialized auditing system port. In this case, the slave devices are connected in the data lines of the gaming machine and the pointing system. For this mode of operation, the information is obtained from the pointing system requirements. Thus, the information will depend on the commands of the pointing system. The de-activation of the gaming machine will consist in the slave device cutting the communication lines to the pointing system, causing an immobilization or deactivation of the gaming machine.

Gaming machine
Meters
From the cashier
system
SAS AFT/EFT
protocol
Port 1

Furthermore, the master device is connected to a gateway which in turn receives the acquired data and processes the information to be sent to a central database server.

On other embodiments of the invention, the system can be arranged on a different network topology, such as a star or grid and use an Ethernet network protocol.

Furthermore, the telemetry system can work without the use of a gateway. However, the services provided and the tasks performed by this hardware element, such as the processing services and routing and data insertion on the database, should have to be carried out in a different device of the telemetry system, for example, directly on the central database server or on a different cloud computer device. This limitation would cause the system to strongly depend on the internet connection. Therefore, the internet connection would have to be critical, highly available and/or redundant. Likewise, such tasks could be distributed on the slave and/or master devices of the telemetry system. However, power efficiency could be affected and computing performance could be less than optimal.

In further embodiments, the database software could be improved with specifically designed software. Likewise, security and stability can be improved in the web servers, data bases or artificial intelligence algorithms could be applied to the acquired data providing a further processing and improved data exploding and display.

The database infrastructure is already improved in the present invention, since the central database is configured to be sizeable and automatizing managing tasks, providing improved availability and durability.

The specially chosen servers for the telemetry system provides virtual cloud based instances protected with keys and security groups.

Along the system, security certificates such as, per example, SSL/TLS certificates are used to validate both the domain and the organization, allowing secure transfer of the information towards the user, protecting the data from computing attacks providing reliability to the entire system.

Furthermore, the web server comprises load balancers which allow a proper distribution of the visitors traffic on the platforms, preventing overloads and collapsing of the web application.

Likewise, a service monitoring tool is provided to monitor the performance in real time with actual metrics and preventing a collapse on the platforms and facilitating decisions when the implementation is performed.

The web server provides a scalable cloud storage, providing several containers that could be available, security and efficiency on the use of the data is provided from the independent databases.

Furthermore, the system provides redirecting and routing of IPs and sub-domain, when the panel is accessed the redirecting features are used since within the panel different platforms are hosted within several servers.

In order to access the servers, access keys are required, in such way that each developer has its own personalized key to access the server, making it impossible to access the server without said key.

Furthermore, joint keys are used to reinforce the access to sensitive parts of the servers wherein only the system administrator and the chief information officer or other privileged users can access.

The server provides an automatic token generation to access the platform, the token is generated, encrypted and sent to the client.

Likewise, a complete notification system is provided to access the platforms informing the client in a fast and efficient manner by using personalized notifications according to the access situations.

The technology used for the backend of the telemetry system, comprises several tools for managing the information acquired by the telemetry system devices. In an exemplary embodiment of the present invention, an interpreted multi-paradigm coding language providing data manipulation and transformation such as Python is used for processing the data. Furthermore, a general purpose coding language such as PHP is provided for making consults to the database and session manipulation from the server. Said tool improves the security level since it is impossible to compromise the displayed information remotely. A further tool for generating REST APIS or other kind of web services is provided, such as Flask by Python, to transfer information between the web application and the data base with improved speed and further security. Accordingly, transfer protocols for representative states are provided to deal with the application request for information.

The front end provided for the web server is a set of developing and data management tools, which may comprise, per example, JavaScript libraries allowing graphic manipulation within an HTML or SVG environment specially focused on graphic chart displaying, such as D3.js.

Furthermore, a JavaScript framework to develop web platforms with single page application and component oriented architecture is provided, preventing the need of loading pages while browsing within the platform, providing an improved structure and scalability to the coding. An example of such framework tool is React.js.

Further libraries linked to React.js are provided, allowing the persistence of status between the different sub-modules within a module, an example of such library is Redux.

Now then, CSS post-processing such as SCSS provides functionality, scalability and order at the moment of creating styles for a web platform.

Likewise, it is desirable to provide a library enabling access to geo-spatial functions and other interactive map information, such as a Google Maps APPI.

Essentially, the web platform requires the use of a markup language, such as HTML to manage the elements within the views of the several modules; a style language to provide the desired design to the view elements such a CSS, a programming language providing functionality to the module views such as JavaScript.

Likewise, other languages, modules or libraries might be added or might replace the aforementioned in order to maintain the data display functionality of the web-based platform.

1. A telemetry system to audit electronic transactions from electronic devices, comprising
a data acquisition system comprising:
a power source;
a gateway device;
at least one smart master device comprising means for electrically acquiring data from a plurality of electronic devices that are being audited, a memory device, at least one processor and a communications device;
a plurality of slave devices, each slave device comprising means for connecting to an electronic device being audited; a secure memory device; a processor; and a communications device;
wherein the power source provides power to the smart master device and the plurality of slave devices;
wherein the power is fed to the smart master device and the plurality of slave devices by electrical cables linking the smart master device and the plurality of slave devices;
wherein the smart master device coordinates the plurality of slave devices;
wherein the smart master device and the plurality of slave devices are connected in a network topology via the communications device of the smart master device and the communications devices of the plurality of slave devices;
wherein the secure memory device in each slave device stores data acquired by the slave device when said slave device is offline, and wherein the processor of each slave device is configured to package the data that is saved while the slave device is offline and to send the packaged data to the smart master device once the connection to the network is enabled;
wherein the smart master device acquires data from the plurality of slave devices, and wherein the processor of the smart master device is configured to prepare the acquired data for uploading to a cloud centralized data base, and wherein the smart master device sends the prepared acquired data to the gateway device;
wherein the gateway device receives the prepared acquired data from the smart master device, and wherein the gateway device uploads the prepared acquired data to a cloud based data base by encapsulating the data and uploading it through a network using a virtual private network (VPN); and
wherein the prepared acquired data includes information regarding electronic transactions performed by the electronic devices to which each of the plurality of slave devices are connected.

2. The system according to claim 1, wherein the network is wired using modified unshielded twisted pair (UTP) cables.

3. The system according to claim 2, wherein the modified UTP cables comprise four pairs of wires, wherein a pair of wires are used to provide a DC voltage to feed power to the smart master device and the plurality of slave devices.

4. The system according to claim 1, wherein a network connection between the smart master device and the gateway device is wireless.

5. The system according to claim 1, wherein the acquired data also comprises information regarding the status of the plurality of slave devices.

6. The system according to claim 1, wherein the acquired data also comprises information regarding the status of connections of the slave devices to the corresponding electronic devices, to the network and/or to the smart master device.

7. The system according to claim 1, wherein each of the plurality of slave devices and the smart master device include a display screen showing historical and statistical data, as well as identification information of the device.
